(19) United States
(12) Patent Application Publication
(10) Pub. No.: US 2011/0233933 A1
(43) Pub. Date: Sep. 29, 2011

(54) PRESSURE REGULATION DEVICE ADAPTED TO MAINTAIN A PREDETERMINED PRESSURE DROP AND DERIVE ENERGY THEREBY

(75) Inventor: Uri Rapoport, Moshav Ben Shemen (IL)

(73) Assignee: Uri Rapoport, Moshav Ben Shemen (IL)

(21) Appl. No.: 13/048,975

(22) Filed: Mar. 16, 2011

Related U.S. Application Data
(60) Provisional application No. 61/316,866, filed on Mar. 24, 2010.

(51) Int. Cl. F03B 15/06; H02K 7/18; F16K 31/12; B01D 29/00

(52) U.S. Cl. 290/7; 290/52; 137/505; 210/348; 210/767

(57) ABSTRACT

A pressure regulation device adapted to maintain a predetermined pressure drop. The device includes: a fluid inlet; a turbine rotated by a flowing fluid; a shaft rotated by said turbine; a generator in mechanical communication with said shaft; a fluid outlet. Wherein said predetermined pressure drop across said turbine is converted into useful work by said generator.

### FIELD OF THE INVENTION

The present invention relates to a device and method for utilization of municipal water supply pressure for reverse osmosis and/or other functions such as generation of electricity. The invention also pertains to a pressure regulation device adapted to maintain a predetermined pressure drop and derive energy thereby and method utilizing the same.

### BACKGROUND OF THE INVENTION

Often municipal water mains are maintained at a relatively high pressure, in order to force water through long pipe runs without undue loss of pressure. This may in many cases involve 8 or 9 Atm of pressure. At residences and other local water-using facilities, the water pressure is regulated down to a more practically useful level, often around the level of 3 or 4 Atm of pressure.

Generally this system is implemented by means of a standard pressure regulator that takes as input the high pressure from the municipal mains, and gives as output the relatively low residential pressure. However it will be noted by the astute observer that this involves a necessary waste of energy in the regulator, which takes a flow of a certain pressure and reduces this pressure, while maintaining the flow rate.

Amongst uses for the energy so spent by the regulator would be to perform reverse osmosis, generate electricity, perform mechanical work, and the like.

Hence, a method for use of the municipal-residential pressure drop to perform useful work meets a long felt need.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 presents a standard pressure regulator;

FIG. 2 presents a pressure regulator according one embodiment of the invention;

FIG. 3a, b present simplified diagram of one embodiment of the device;

FIG. 4 presents a pressure regulator according an embodiment of the invention adapted to force brackish water through an ion selective membrane;

FIG. 5 presents a negative feedback device for use in the invention; and

FIG. 6 schematically illustrates a hollow fibers stack (upper draw) and a sheet-like membrane (lower draw) that provides a pressure regulator according yet another embodiment of the invention.

### SUMMARY OF THE INVENTION

The present invention comprises a system and method for regulating pressure in fluid lines while utilizing the pressure drop for generation of mechanical or electrical energy, or performance of useful work such as desalination of water. The device is utilizable, in a non-limiting manner, in ships, marine vessels, home, buildings, malls, and outdoor facilities, agriculture and industry, hospitals, schools and army bases, in remote and standalone facilities and locations etc.

It is within the core of the present invention to provide a pressure regulation device adapted to maintain a predetermined pressure drop and derive energy thereby consisting of:

a. a fluid inlet;
b. a turbine adapted to be spun by a flowing fluid;
c. a shaft adapted to be rotated by said turbine;
d. a generator in mechanical communication with said shaft;
e. a fluid outlet;
wherein a pressure drop over said turbine is converted into useful work of said generator.

It is within provision of the invention to provide the aforementioned device further provided with a feedback loop consisting of a pressure sensor in fluid communication with said outlet and in communication with said generator adapted to increase the pressure drop over said generator with increase of pressure in said outlet 303 by means of increasing the load upon said generator.

It is within provision of the invention to provide the aforementioned device wherein said communication between said pressure sensor and said generator is selected from the group consisting of: fluid communication, electric or magnetic means etc.

It is within provision of the invention to provide the aforementioned device wherein said feedback loop is implemented by means of a variable coupling between clutch plates.

It is within provision of the invention to provide the aforementioned device wherein said feedback loop is implemented by means of a variable electrical load upon said generator.

It is within provision of the invention to provide the aforementioned device adapted for use with a fluid selected from the group consisting of: hydraulic fluid, such as glycol-ether based fluids, silicone/DOT 5-based fluids etc, air, steam or oil.

It is within provision of the invention to provide the aforementioned device wherein said generator is a desalinated water generator adapted to force water containing a first concentration of salts past a filter largely blocking passage of said salts, thereby providing water containing a second lower concentration of salts.

It is within provision of the invention to provide the aforementioned device wherein said generator is an electrical generator.

It is within provision of the invention to provide a method for utilization of the pressure drop over a pressure regulation device consisting of:

a. conducting fluid through an inlet maintained at an inlet pressure;
b. lower the pressure in said fluid by means of a turbine adapted to be spun by said fluid, said turbine spinning upon a shaft adapted to be rotated by said turbine;
c. generating useful work by means of a generator in mechanical communication with said shaft; and
d. conducting said fluid out of an outlet;
whereby a pressure drop over said turbine is converted into useful work of said generator.

It is within provision of the invention to provide the aforementioned method further utilizing feedback by means of a feedback loop consisting of a pressure sensor in fluid communication with said outlet and in communication with said generator, said feedback increasing the pressure drop over said generator with increase of pressure in said outlet.

It is within provision of the invention to provide the aforementioned method wherein said communication between said pressure sensor and said generator is selected from the group consisting of fluid communication, electric or magnetic means etc.

It is within provision of the invention to provide the aforementioned method adapted for use with a fluid selected from the group consisting of water, steam, hydraulic fluid, such as glycol-ether based fluids, silicone/DOT 5-based fluids etc, air, steam or oil.

It is within provision of the invention to provide the aforementioned method wherein said generator is a desalinated water generator adapted to force water containing a first concentration of salts past a filter largely blocking passage of said salts, thereby providing water containing a second lower concentration of salts.

It is within provision of the invention to provide the aforementioned method wherein said generator is an electrical generator.

It is within provision of the invention to provide the aforementioned method wherein said feedback loop is implemented by means of a variable coupling between clutch plates.

It is within provision of the invention to provide the aforementioned method wherein said feedback loop is implemented by means of a variable electrical load upon said generator.

It is within provision of the invention to provide a pressure regulation device adapted to maintain a predetermined pressure drop and derive energy thereby consisting of: a fluid inlet for flowing in high pressure fluid; at least one filter adapted to filter or otherwise treat said fluids; at least one first fluid outlet flowing low pressure, filtered or otherwise treated fluids; at least one second fluid outlet for flowing low pressure, salty or otherwise non-treated fluids, said salty or otherwise non-treated fluids comprising salts or other contaminants that were filtered out or otherwise resulted from said filtered or otherwise treated fluids; wherein a pressure drop over said filter is utilized to filter or otherwise treat said high pressure fluid. It is also within provision of the invention to provide a method for utilizing a pressure drop over a filter to filter or otherwise treat high pressure fluids, said method consisting of: conducting high pressure fluid through a fluid inlet; lowering the pressure of said fluid by means at least one filter adapted to filter or otherwise treat said fluids; conducting a first portion of said filtered or treated fluid by means of at least one filter; and conducting a second portion of said filtered or treated fluid by means of at least one filter; said second portion said of fluids comprising salts or other contaminants that were filtered out or otherwise resulted from said filtered or otherwise treated fluids; whereby a pressure drop over said turbine is utilized to filter or otherwise treat said high pressure fluid. While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a reverse osmosis system running off municipal water pressure.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer e.g., 1, 5, or 10.

The term ‘about’ refers hereinafter to a value being 25% more or less then the indicated value.

The term ‘generator’ refers hereinafter to a means for conversion of mechanical energy, for instance and electrical generator, a desalinated water generator, or the like.

The term ‘turbine’ hereinafter refers to a device adapted to extract energy from a flow of fluid. In so doing the downstream fluid is left at a lower energy state than the upstream fluid, for example having the same velocity but lower pressure.

In a preferred embodiment of the invention, the relatively high pressure in the municipal water mains (before regulation down to domestic pressure level) is utilized to provide the working power for a reverse osmosis system, and/or auxiliary electrical and/or mechanical power.

Let us denote the high pressure in a municipal water main as p₁, and the lower pressure in a residential water system as p₂. The present system, instead of wasting the power inherent in the flow of water down this pressure difference in a standard pressure regulator, instead utilizes this power to perform useful work such as reverse osmosis, electricity generation, or the like. If within the household a flow rate f is used, then in principle a power

P=(p₁−p₂)f

may be extracted from the system. For example if a flow rate of 1 liter/s is used, the municipal pressure is 8 bar, and the household pressure is 3 bar, then a power

$$\begin{matrix}( {p}_{1} - {p}_{2} ) f = ( 8 \times {10}^{5} - 3 \times {10}^{5} ) \frac{N}{{m}^{2}} \times 0.001 \frac{{m}^{3}}{s} \\ = 500 Nm \text{/} s \\ = 500 W\end{matrix}$$

is in principle available, which is in common practice not utilized. As will be made clear in the following, this power may in fact be extracted by a number of methods. In a preferred embodiment, a system of reverse osmosis is powered by the pressure drop.

The membranes used for reverse osmosis generally have a dense barrier layer where separation of water from salts occurs. The membrane is designed to allow only water to pass through this dense layer while preventing the passage of solutes (such as salt ions). This process requires that a high pressure be exerted on the high concentration side of the membrane, usually about 2 to about 17 bar (about 30 to about 250 psi) for fresh and brackish water, and about 40 to about 70 bar (about 600 to about 1000 psi) for seawater, which has around 24 bar (about 350 psi) natural osmotic pressure that must be overcome. In one embodiment of the invention

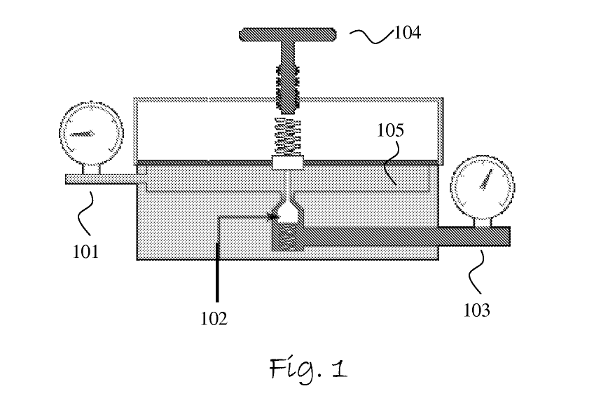

In a standard pressure regulator (FIG. 1) the output pressure 101 is fixed by means of the constriction poppet valve 102, which reduces the input pressure 103 by a certain amount (in this case depending upon the position of the adjustment screw 104, which may be absent in the case of a fixed-output pressure regulator). The poppet valve regulates pressure in the following way. As pressure in the upper chamber 105 increases, the poppet is pushed upward, causing it to constrict the flow around it and reduce flow, bringing the pressure back down. By adjusting the adjustment screw, the downward pressure on the poppet can be increased, requiring more pressure in the upper chamber to maintain equilibrium. As will be clear to one skilled in the art, the decrease in pressure is not exploited to perform any useful function, and instead the associated energy is lost as heat, noise, and the like.

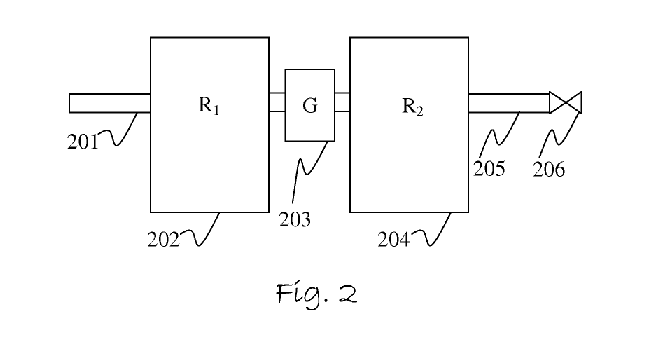

In one embodiment of the invention, depicted in FIG. 2, an input reservoir R₁ (202) is maintained at municipal pressure, while an output reservoir R₂ (204) is maintained at residential pressure. These are connected by the generator G (203) which may be for example a reverse osmosis unit of 5 bar pressure drop, a water-powered electrical generator of 5 bar pressure drop, or the like. Water will only be pumped through the system when the tap 206 is opened, mimicking the action of a regular household pressure regulator, but producing useful work in the generator or reverse osmosis unit.

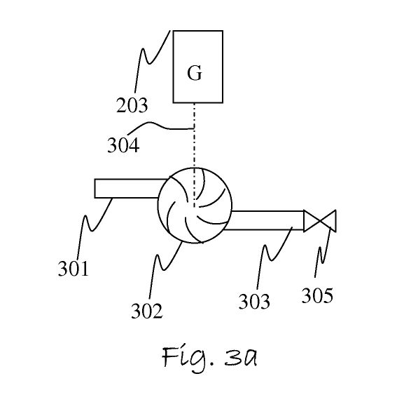

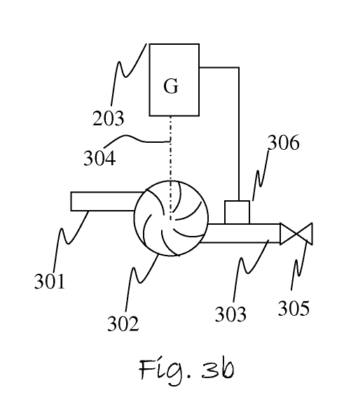

A simplified diagram of one embodiment of the device is shown in FIGS. 3a,b. Here the inlet 301 leads to an impeller 302, which is spun by the flow of water when the tap 305 allows water out the outlet 303. The spinning shaft of this impeller 302 is mechanically linked by means of a shaft 304 to a water or electricity generation unit 203, which uses the physical rotation of the shaft 304 to, for example, produce electricity in an electrical generator, produce fresh water from brackish water in a reverse osmosis or other water purification device, perform mechanical work, or the like. In order to guarantee a specific required pressure drop such as 5 bar, the load on the generation unit 203 may be varied using feedback, as shown in FIG. 3b. Here the pressure tap or sensor 306 is employed to either read the output pressure (e.g. as a voltage) or physically feed this pressure back (e.g. in a fluid line) to the generation unit 203. The load upon the generation unit 203 is varied in accordance with this feedback, increasing the load with increasing pressure. As will be obvious to one skilled in the art, the value of the output pressure reached by the system can be varied, for example by means of a constricting poppet and adjustment screw that decreases the pressure in the feedback line, or by means of a voltage divider that decreases the voltage that obtains in the feedback loop.

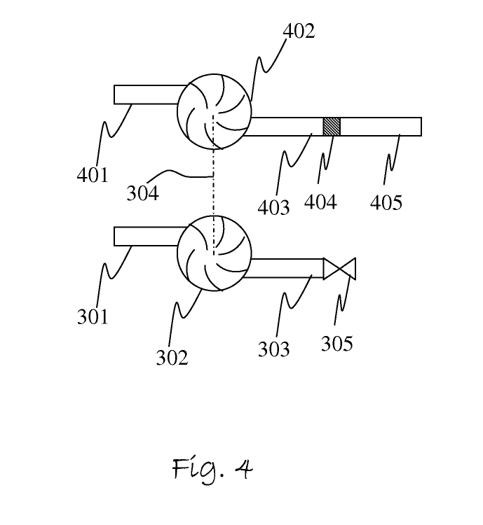

Another embodiment of the invention intended for forcing brackish water through an ion selective membrane is shown in FIG. 4. Here again the inlet 301 leads to a turbine 302, which is spun by the flow of water when the tap 305 allows water out the outlet 303. The spinning shaft of this turbine 302 is mechanically linked by means of a shaft 304 to an impeller 402, which is rotated thereby. This rotation forces brackish water from the input 401 to the output 403 at a certain pressure and rate determined by the physical size of the impeller 402 and the mechanical advantage of the linkage shaft 304. The linkage shaft 304 may be geared up or down as will be obvious to one skilled in the art, such that turbine 402 turns at a different frequency than impeller 302. The water (or other fluid) thus forced out of the output 403 may be provided at a variety of pressures as necessary, for example by means of a variable gear, output pipe diameter change, or the like. In one embodiment the brackish water is forced past the ion selective membrane 404, which (for example) lets only water molecules past but does not allow chlorine or sodium ions to pass. Thus the water exiting the system from output 405 is devoid of sodium or chlorine, and the desalination thereof has been effected. As before, the output pressure can be precisely regulated if desired by means of a feedback loop that increases the load upon the impeller 402 with increasing output pressure. This will increase the back pressure upon the turbine 302, increasing the pressure drop across it and decreasing the output pressure, thus regulating the output pressure to a fixed value.

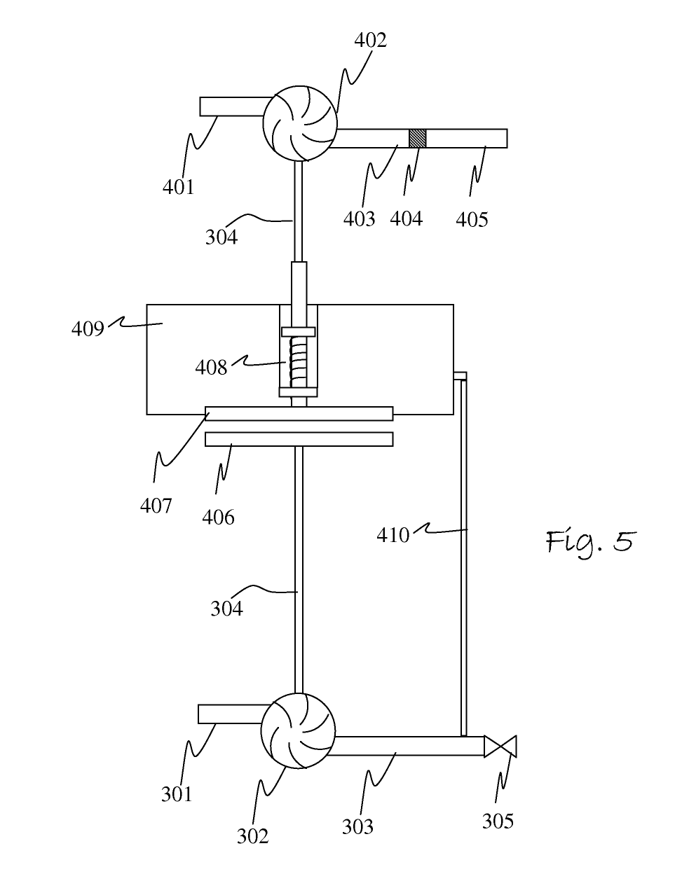

One embodiment of a negative feedback device for use in the invention is depicted in FIG. 5. Here the shaft connecting the turbine 302 and the impellor 402 is split to two parts which are coupled to a variable degree by the clutch disks 406, 407. In this example the top clutch disk 407 is pushed down towards the lower clutch disk 406 by pressure in chamber 409, which is in fluid communication with the output line 303 of the system by means of pressure line 410. Thus when the output pressure increases, the top clutch disk 407 is forced into closer contact with the lower clutch disk 406 thereby increasing the coupling between the clutch disks and increasing the load upon the turbine 302, tending to increase the pressure drop across the turbine 302 and decrease the pressure in the output line 303 thereby effecting the negative feedback necessary to stabilize the output pressure. To provide a restoring force a spring 408 tending to force the top clutch disk 407 away from the bottom clutch disk 406 is provided. As in a standard pressure regulator, the equilibrium position of the clutch disks can be adjusted e.g. by means of a screw changing the compression of spring 408 as will be obvious to one skilled in the art.

Another embodiment of the invention intended for providing a pressure regulation device adapted to maintain a predetermined pressure drop and derive energy thereby consisting of a fluid inlet 711 or 721 for flowing in high pressure fluid; at least one filter 713 or 723 adapted to filter or otherwise treat the fluids; at least one first fluid outlet (714 or 724) flowing low pressure, filtered or otherwise treaded fluids; at least one second fluid outlet (712 or 722) for flowing low pressure, salty or otherwise non-treated fluids, the salty or otherwise non-treated fluids comprising salts or other contaminants that were filtered out or otherwise resulted from the filtered or otherwise treated fluids; wherein a pressure drop over the filter 713 or 723 is utilized to filter or otherwise treat the high pressure fluid. Another embodiment of the invention intended for providing a method for utilization a pressure drop over a filter to filter or otherwise treat high pressure fluids, the method consisting of: conducting high pressure fluid through a fluid inlet 711 or 721; lowering the pressure of the fluid by means at least one filter 713 or 723 adapted to filter or otherwise treat the fluids; conducting a first portion of the filtered or treated fluid by means of at least one filter 713 or 723; and conducting a second portion of the filtered or treated fluid by means of at least one filter 713 or 723; the second portion the of fluids comprising salts or other contaminants that were filtered out or otherwise resulted from the filtered or otherwise treated fluids; whereby a pressure drop over the turbine 302 is utilized to filter or otherwise treat the high pressure fluid.

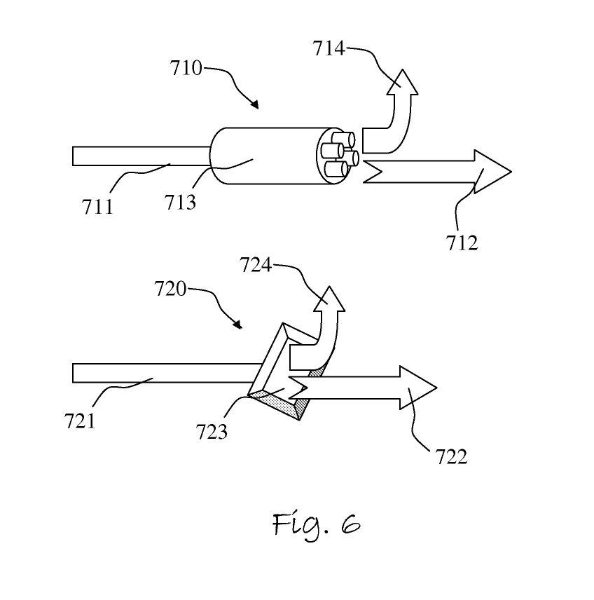

Reference is now made to FIG. 6 which illustrates a hollow fibers' stack (710, upper draw) and a sheet-like membrane (720 lower draw) that provides a pressure regulator according yet another embodiment of the invention. In this set of drawings, the membranes themselves are provided as the pressure regulator. Hence, the upper draw schematically presents a system wherein an inlet pipe (711) is facilitating the flow of high pressure fluid towards an outlet pipe (712) via one or more stacks (bundles) of hollow fibers' membranes (reverse osmosis filters for example, 713). The pressure of the fluid is directly reduced by the membranes in a manner, e.g., sea waters are filtered in a manner that drinking waters are purged to pipe 714 and the remaining salty waters are disposed in pipe 712. Similarly, the lower draw schematically presents a system wherein an inlet pipe (721) is facilitating the flow of high pressure fluid towards an outlet pipe (722) via one or more stacks of sheet-like membranes (ultra filtration membranes for example, 723). The pressure of the fluid is directly reduced by the membranes in a manner, e.g., brackish waters are purified in a manner that clean or drinkable waters are purged to pipe 724 and the remaining salty waters are disposed in pipe 722.

It is in the scope of the invention wherein the term ‘reverse osmosis’ refers, inter alia, to a liquid filtration method for removing many types of large atomic molecules from smaller molecules, by forcing the liquid at high pressure through a membrane with pores (holes) just big enough to allow the small molecules to pass through. Reverse osmosis of the present invention is utilizable e.g., in drinking water purification from seawater, removing the salt and other substances from the water molecules. However, the process is also useable for filtering many other types of liquids. The predominant removal mechanism of the reverse osmosis system defined in this invention in membrane filtration is straining, or size exclusion, so the process can theoretically achieve perfect exclusion of particles regardless of operational parameters such as influent pressure and concentration. Reverse Osmosis, however involves a diffusive mechanism so that separation efficiency is dependent on influent solute concentration, pressure applied: i.e., inlet high pressure and outlet relatively low pressure, and water flux rate. It works by using pressure to force a solution through a membrane, retaining the solute on one side and allowing the pure solvent to pass to the other side.

It is also in the scope of the invention wherein the term ‘Ultra-filtration’ or ‘UF’ refers, inter alia, to a variety of membrane filtration in which hydrostatic pressure forces a liquid against a semi-permeable membrane. Suspended solids and solutes of high molecular weight are retained, while water and low molecular weight solutes pass through the membrane. This separation process is used in industry and research for purifying and concentrating macromolecular (103-106 Da) solutions, especially protein solutions. The term Ultra filtration is interchangeably referring to microfiltration or nano-filtration. The ultra filtration is applied, according one embodiment of the invention in cross-flow mode and separation in ultra filtration undergoes concentration polarization. Various membrane geometrics are possible, e.g., Spiral wound module which consists of large consecutive layers of membrane and support material rolled up around a tube maximizes surface area is less expensive, however, more sensitive to pollution; Tubular membrane wherein the feed solution flows through the membrane core and the permeate is collected in the tubular housing; Hollow fiber membrane, wherein the modules contain several small (0.6 to 2 mm diameter) tubes or fibers; and wherein the feed solution flows through the open cores of the fibers and the permeate is collected in the cartridge area surrounding the fibers.

The filtration can be carried out either “inside-out” or “outside-in”. The term also referring to Pressurized system or pressure-vessel configuration: TMP (trans-membrane pressure) is generated in the feed by a pump, while the permeate stays at atmospheric pressure. Pressure-vessels are generally standardized, allowing the design of membrane systems to proceed independently of the characteristics of specific membrane elements; and to Immersed system, wherein membranes are suspended in basins containing the feed and open to the atmosphere. Pressure on the influent side is limited to the pressure provided by the feed column. TMP is generated by a pump that develops suction on the permeate side. Ultra filtration, like other filtration methods can be run as a continuous or batch process.

As will be obvious to one skilled in the art many alternative forms of this variable coupling can be used, including mechanical as well as electrical means such as by increasing an electrical load upon an output electrical generator by means (for example) of pulse-width modulation of the load connection to the output generator.

It is also in the scope of the invention wherein the aforesaid filtration or fluids treatment is applied in various industries and for various purposes, such as Fractionation of proteins; Clarification of fruit juice; Recovery of vaccines and antibiotics from fermentation broth; Laboratory grade water purification; Wastewater treatment; Drinking water disinfection (including removal of viruses); and/or Removal of endocrines and pesticides combined with Suspended Activated Carbon pretreatment

In general the turbine will consist of a rotor supplied with a series of vanes rotating upon a shaft. However, other devices for extraction of energy from a fluid flow are possible and within provision of the invention. As will be obvious to one skilled in the art, the downstream pressure will in general be less than the upstream pressure, thus allowing for the basic function of pressure regulation while performing useful work.

As will be clear to one skilled in the art, the device can be operated effectively either with or without feedback. In the case of a device not using feedback, the output pressure may vary somewhat, which may be acceptable for domestic uses. The actual output pressure can be determined by the parameters of the turbine and generator used, generally depending upon the back pressure exerted by the turbine. This back pressure can be fixed by changing the nature of the turbine foils and the mechanical load imposed upon its rotation by the generating unit.

The generating unit as mentioned above may be adapted either for generation of electrical power, desalinated water, mechanical work, or otherwise, as will be obvious to one skilled in the art.

1. A pressure regulation device adapted to maintain a predetermined pressure drop comprising:
a. a fluid inlet 201;
b. a turbine 302 rotated by a flowing fluid;
c. a shaft 304 rotated by said turbine;
d. a generator 203 in mechanical communication with said shaft 304;
e. a fluid outlet 303;
wherein said predetermined pressure drop across said turbine 302 is converted into useful work by said generator 203.

2. The device of claim 1 further comprising a feedback loop for generating feedback, said feedback loop comprising a pressure sensor 306 in fluid communication with said outlet 303 and said generator 203, said feedback loop is adapted to increase said pressure drop across said generator 203 with an increase of pressure in said outlet 303 by increasing a load on said generator.

3. The device of claim 2 wherein said communication between said pressure sensor 306 and said generator 203 is selected from the group consisting of: fluid communication, electric or magnetic means.

4. The device of claim 2 wherein said feedback loop is implemented by a variable coupling between two clutch plates.

5. The device of claim 2 wherein said feedback loop is implemented by a variable electrical load acting on said generator 203.

6. The device of claim 1 is adapted for use with a fluid selected from the group consisting of: water, hydraulic fluid, air, steam or oil.

7. The device of claim 1 wherein said generator is a desalinated water generator adapted to force water containing a first concentration of contaminants through a filter substantially blocking passage of said first concentration of contaminants and providing water containing a second concentration of contaminants.

8. The device of claim 1 wherein said generator is an electrical generator.

9. A method for utilizating a pressure drop over a pressure regulation device comprising:
a. conducting a fluid through an inlet 301 maintained at an inlet pressure;
b. decreasing the pressure in said fluid by a turbine 302 rotated by said fluid, said turbine rotating on a shaft 304;
c. generating useful work by a generator 203 in mechanical communication with said shaft 304;
d. conducting said fluid out of an outlet 303;
wherein said pressure drop over said turbine 302 is converted into useful work by said generator 203.

10. The method of claim 9 further comprising a feedback loop, said feedback loop for generating feedback comprises a pressure sensor 306 in fluid communication with said outlet 303 and in fluid communication with said generator 203, said feedback increasing said pressure drop over said generator 203 with increase of pressure in said outlet 303.

11. The method of claim 10 wherein said communication between said pressure sensor 306 and said generator 203 is selected from the group consisting of: fluid communication, and electric or magnetic means.

12. The method of claim 8 adapted for use with a fluid selected from the group consisting of: water, air, steam, hydraulic fluid, air, steam or oil.

13. The method of claim 8 wherein said generator is a desalinated water generator adapted to force water containing a first concentration of contaminants through a filter largely blocking passage of said contaminants, thereby providing water containing a second concentration of contaminants.

14. The method of claim 8 wherein said generator is an electrical generator.

15. The method of claim 10 wherein said feedback loop is implemented by a variable coupling between two clutch plates.

16. The method of claim 15 wherein said feedback loop is implemented by a variable electrical load upon said generator 203.

17. A pressure regulation device adapted to maintain a predetermined pressure drop: comprising:
a. a fluid inlet for high pressure fluid flow;
b. at least one filter for filtering said fluids;
c. at least one first fluid outlet for outputting low pressure fluid flow of filtered fluids;
d. at least one second fluid outlet for low pressure fluid flow of non-treated fluids, said non-treated fluids comprising filtered contaminants from said treated fluids;
wherein a pressure drop across said at least one filter is utilized to treat said high pressure fluid flow.

18. A method for utilization a pressure drop over a filter to filter high pressure fluids, said method consisting of:
a. transferring a high pressure fluid through a fluid inlet;
b. decreasing the pressure of said fluid by at least one filter adapted to treat said fluids;
c. transferring a first portion of said treated fluid by at least one filter; and
d. transferring a second portion of said treated fluid by at least one filter; said second portion said of fluids comprising filtered contaminants removed from said treated fluids;
whereby said pressure drop over said filter is utilized to treat said high pressure fluids.

19. The device of claim 7 wherein said second concentration of contaminants is lower than said first concentration of contaminants.

20. The method of claim 13 wherein said second concentration of contaminants is lower than said first concentration of contaminants.

21. A pressure regulation device according to claim 18 said treating fluids comprises filtering said fluids.

22. A pressure regulation device according to claim 17 said contaminants comprises salts.

23. A pressure regulation device according to claim 18 said contaminants comprises salts.

24. The device of claim 2 wherein said feedback loop is implemented by a variable mechanical load acting on said generator.
